(19) United States
(12) Patent Application Publication
(10) Pub. No.: US 2010/0253617 A1
(43) Pub. Date: Oct. 7, 2010

(54) Portable Electronic Apparatus and Control Method of Portable Electronic Apparatus

(75) Inventors: Taro Iio, Yokohama-shi (JP); Tomohiro Inagaki, Yokohama-shi (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/438,521

(22) PCT Filed: Aug. 20, 2007
(86) PCT No.: PCT/JP2007/066128

§ 371 Date: Jun. 24, 2010

(30) Foreign Application Priority Data
Aug. 25, 2006 (JP) 2006-229378

(51) Int. Cl. G09G 5/00

(52) U.S. Cl. 345/156

(57) ABSTRACT

A portable electronic apparatus and a control method of the portable electronic apparatus with excellent operability capable of surely reflecting a user's intended input operation are provided. The portable electronic apparatus and the control method comprise: a first sensor group G1 including a plurality of sensor elements L1 to L4 that are consecutively lined up and arranged and that detect contact; and a control unit 110 that monitors output of the plurality of sensor elements and that executes control based on change in a sensor element that has detected contact, wherein the control unit 110 includes a first contact detection mode for changing from a first state, in which none of the plurality of sensor elements has detected contact, to a second state after detecting that any of the sensor elements has detected contact, changing again to the first state after detecting that a state of none of the sensor elements detecting contact in the second state has continued for a certain time, and executing control according to the change in the contact detection in the plurality of sensor elements occurred in the second state.

### CROSS-REFERENCE TO RELATED APPLICATION

This application claims priority from Japanese Patent Application No. 2006-2299378, filed Aug. 25, 2006, the entire contents of which are incorporated herein by reference.

### TECHNICAL FIELD

The present invention relates to a portable electronic apparatus, and more specifically, to a portable electronic apparatus and a control method of the portable electronic apparatus including a plurality of sensor elements as operation input units for detecting contact.

### BACKGROUND ART

Conventionally, various interfaces and configurations have been developed as operation input units of a portable electronic apparatus. An example of a known technique includes a rotary dial input device arranged in a portable electronic apparatus in which a cursor displayed on a display unit is moved according to the amount of rotation of the rotary dial input device (see, for example, Patent Document 1).

However, the technique disclosed in Patent Document 1 uses a “rotary dial” involving physical and mechanical rotations, and the technique is prone to malfunctions and failures by mechanical abrasion and other reasons. Therefore, there were problems that the maintenance of the operation input units was needed, and the service life was short.

Techniques that may solve the problems are proposed in which, for example, touch sensor elements without physical and mechanical rotations are used as operation input units (see, for example, Patent Documents 2 and 3). In the proposed techniques, a plurality of touch sensor elements are circularly arranged, and contact detections by individual touch sensor elements are monitored. Consecutive contact detections are determined as a generation of a movement instruction of the cursor, and the cursor is moved according to the movement of the contact detected units.

### Patent Document 1: Japanese Patent Laid-Open No. 2003-280792

### Patent Document 2: Japanese Patent Laid-Open No. 2005-522797

### Patent Document 3: Japanese Patent Laid-Open No. 2004-311196

### SUMMARY OF INVENTION

### Technical Problem

The techniques disclosed in Patent Documents 2 and 3 detect whether the plurality of circularly arranged touch sensor elements are rotated clockwise or counterclockwise and move the cursor in one or the other of the two directions according to the detected direction.

However, the case of the portable electronic apparatus is made compact because the portability is prioritized. Therefore, the operation input units including the touch sensor elements are also formed small. As a result, if a quick input operation is made, the ball of the finger is departed from the operation input unit, and the user's intended input operation and the input operation result detected by the touch sensor elements may not correspond. A similar phenomenon may occur when, for example, an input operation is made in a moving vehicle, as the vibrations of the car are transmitted to the case or the finger and the finger is momentarily departed from the touch sensor elements.

An object of the present invention made in view of the foregoing circumstances is to provide a portable electronic apparatus and a control method of the portable electronic apparatus with excellent operability capable of surely reflecting a user's intended input operation.

### Solution to Problem

An invention of a portable electronic apparatus according to a first aspect for attaining the object is characterized by comprising: a first sensor group including a plurality of sensor elements that are consecutively lined up and arranged and that detect contact; and a control unit that monitors output of the plurality of sensor elements and that executes control based on change in a sensor element that has detected contact, wherein the control unit includes a first contact detection mode for changing from a first state, in which none of the plurality of sensor elements has detected contact, to a second state after detecting that any of the sensor elements has detected contact, changing again to the first state after detecting that a state of none of the sensor elements detecting contact in the second state has continued for a certain time, and executing control according to the change in the contact detection in the plurality of sensor elements occurred in the second state.

An invention according to a second aspect is the portable electronic apparatus according to the first aspect, characterized in that the control unit includes buffering means for storing element identification information for identifying a sensor element that has detected contact based on monitoring result of the output of the first sensor element group and release information indicating that the state of none of the sensor elements detecting contact in the second state has continued for a certain time and changes to the first state or the second state based on the information stored in the buffering means.

An invention according to a third aspect is the portable electronic apparatus according to the second aspect, characterized in that the buffering means stores the release information if the first sensor element group detects abnormal contact.

An invention according to a fourth aspect is the portable electronic apparatus according to the first aspect, characterized by further comprising a second sensor element group including a plurality of sensor elements that are consecutively lined up and arranged and that detect contact, wherein at least one ends of the first sensor element group and the second sensor element group are arranged close to each other, and the control unit can execute a first control based on the contact detection using both of the first sensor element group and the second sensor element group in the first contact detection mode.

An invention according to a fifth aspect is the portable electronic apparatus according to the second aspect, characterized by further comprising a second sensor element group including a plurality of sensor elements that are consecutively lined up and arranged and that detect contact, wherein at least one ends of the first sensor element group and the second sensor element group are arranged close to each other, and the control unit can execute a first control based on the contact detection using both of the first sensor element group and the second sensor element group in the first contact detection mode.

An invention according to a sixth aspect is the portable electronic apparatus according to the third aspect, characterized by further comprising a second sensor element group including a plurality of sensor elements that are consecutively lined up and arranged and that detect contact, wherein at least one ends of the first sensor element group and the second sensor element group are arranged close to each other, and the control unit can execute a first control based on the contact detection using both of the first sensor element group and the second sensor element group in the first contact detection mode.

An invention according to a seventh aspect is the portable electronic apparatus according to the fourth aspect, characterized in that the control unit can execute a second control based on contact detection using one of the first sensor element group and the second sensor element group in a second contact detection mode that is different from the first contact detection mode.

An invention according to an eighth aspect is the portable electronic apparatus according to the fifth aspect, characterized in that the control unit can execute a second control based on contact detection using one of the first sensor element group and the second sensor element group in a second contact detection mode that is different from the first contact detection mode.

An invention according to a ninth aspect is the portable electronic apparatus according to the sixth aspect, characterized in that the control unit can execute a second control based on contact detection using one of the first sensor element group and the second sensor element group in a second contact detection mode that is different from the first contact detection mode.

An invention according to a tenth aspect is the portable electronic apparatus according to the fourth aspect, characterized in that electronic components other than the sensor elements are arranged between adjacent ends of the first sensor element group and the second sensor element group.

An invention according to an eleventh aspect is the portable electronic apparatus according to the fifth aspect, characterized in that electronic components other than the sensor elements are arranged between adjacent ends of the first sensor element group and the second sensor element group.

An invention according to a twelfth aspect is the portable electronic apparatus according to the sixth aspect, characterized in that electronic components other than the sensor elements are arranged between adjacent ends of the first sensor element group and the second sensor element group.

An invention according to a thirteenth aspect is the portable electronic apparatus according to the seventh aspect, characterized in that electronic components other than the sensor elements are arranged between adjacent ends of the first sensor element group and the second sensor element group.

An invention according to a fourteenth aspect is the portable electronic apparatus according to the eighth aspect, characterized in that electronic components other than the sensor elements are arranged between adjacent ends of the first sensor element group and the second sensor element group.

An invention according to a fifteenth aspect is the portable electronic apparatus according to the ninth aspect, characterized in that electronic components other than the sensor elements are arranged between adjacent ends of the first sensor element group and the second sensor element group.

Furthermore, an invention of a control method of a portable electronic apparatus according to a sixteenth aspect for attaining the object is characterized by comprising: consecutively lining up and arranging a plurality of sensor elements that detect contact; monitoring output of the plurality of sensor elements with a control unit; and changing the control unit from a first state, in which none of the plurality of sensor elements has detected contact, to a second state after detecting that any of the sensor elements has detected contact, changing again to the first state after detecting that a state of none of the sensor elements detecting contact in the second state has continued for a certain time, and executing control, by the control unit, according to the change in the contact detection in the plurality of sensor elements occurred in the second state.

Furthermore, a portable electronic apparatus according to a seventeenth aspect for attaining the object is characterized by comprising: a plurality of sensor elements; and a control unit that detects contact to the sensor elements, wherein the control unit sets a first state, in which contact to the sensor elements is not detected, and a second state to which a transition is made after contact to any of the sensor elements is detected, when the second state is set, detects a state that no contact is made to the sensor elements has continued for a certain time to set the state to the first state from the second state, and executes control according to the change in the contact detection of the sensor elements in the second state.

An invention according to an eighteenth aspect is the portable electronic apparatus according to the seventeenth aspect, characterized in that the control according to the change in the contact detection of the sensor elements is control for removing the lock of the portable electronic apparatus.

Furthermore, an invention of a portable electronic apparatus according to a nineteenth aspect for attaining the object is characterized by comprising a plurality of sensor elements; and a control unit that detects contact to the sensor elements, wherein the control unit sets a first state, in which contact to the sensor elements is not detected, and a second state to which a transition is made after contact to any of the sensor elements is detected, and when the second state is set, maintains the second state if a state that the contact to the sensor elements is not made is within a certain time.

### ADVANTAGEOUS EFFECTS ON INVENTION

According to the present invention, a state that none of the sensor elements has detected contact is continued for a certain time in the second state is detected, and control according to the change in the contact detection in the plurality of sensor elements occurred in the second state is executed. Therefore, even if the finger momentarily departs during the operation of a sensor element group, it is processed as a continuing series of input operations if the departed time is within a certain time. Therefore, the user's intended input operation can be surely reflected, and the operability can be improved even if a quick input operation is performed when the size of the sensor element group is small, or even if an input operation is performed in an environment susceptible to external vibrations such as during moving.

### BRIEF DESCRIPTION OF DRAWINGS

FIG. 1 is a block diagram of a basic configuration of a cellular phone terminal according to an embodiment of the present invention;

FIG. 2 is a perspective view of the cellular phone terminal according to the embodiment;

FIG. 3 is a detailed functional block diagram of the cellular phone terminal according to the embodiment;

FIG. 4 is a block diagram of a more detailed configuration of a touch sensor function of the cellular phone terminal according to the embodiment;

FIG. 5 is a plan view of an arrangement of constituent elements of a sensor unit and a sub display unit of the cellular phone terminal according to the embodiment;

FIG. 6 is an exploded perspective view of FIG. 5;

FIG. 7 is a schematic block diagram for explaining processing of contact detection data from sensor elements in the cellular phone terminal according to the embodiment;

FIG. 8 is a diagram for explaining an operation of a “half-turn detection mode” in the cellular phone terminal according to the embodiment;

FIG. 9 is a diagram for explaining an operation of the “half-turn detection mode” in the cellular phone terminal according to the embodiment;

FIG. 10 is a schematic diagram of another sensor element detection state;

FIG. 11 is a flow chart for explaining another operation of the “half-turn detection mode” applying sixteen sensor element detection states shown in FIG. 10;

FIG. 12 is a diagram for explaining a fixing processing when the process of the flow chart of FIG. 11 is applied to contact from a sensor element L1 to a sensor element L4 of FIG. 10;

FIG. 13 is a flow chart for explaining a basic operation of a “circular detection mode” in the cellular phone terminal according to the embodiment;

FIG. 14 is a schematic diagram for explaining one specific example of the “circular detection mode” according to the embodiment; and

FIG. 15 is a flow chart for explaining an operation of the “circular detection mode” shown in FIG. 14.

### REFERENCE SIGNS LIST

100 cellular phone terminal
110 control unit
120 sensor unit
130 display unit
140 storage unit
142 storage region
144 external data storage region
150 information processing function unit
160 telephone function unit
220 camera
230 light
300 pre-processing unit
310 A/D converter
320 control unit
330 storage unit
AP1 sub display unit display application
AP2 lock security application
AP3 application
AP3 other applications
AP4 radio application
API application program interface
APIR infrared-ray communication application
APRF RFID application
AUD audio driver
BA base application
CLK OS timer
CNF confirming unit
COM communication unit
DL device layer
EAP earphones
FLG flag storage unit
G1 first sensor element group
G2 second sensor element group
IH interrupt handler
IR infrared-ray communication unit
IRD infrared-ray communication driver
KEY key operation unit
KSP key scan port driver
MIC microphone
NTF result notification unit
OCD open/close detecting device
PNL panel
PR protocol
PS power supply
PSCON power supply controller
QUE queue
RD radio driver
RFD RFID driver
RFID RFD) module
RM radio module
SI serial interface unit
SIMON monitor unit
SP speaker
SW switch unit
SWCON switch control unit
TSBA touch sensor base application block
TSD touch sensor driver
TDB touch sensor driver block
TSM touch sensor module
L1 to L4 sensor elements
R1 to R4 sensor elements
ELD sub display unit
PNL panel
SP1 and SP2 separation sections
SW1 to SW4 tact switches
AR1 and AR2 arrows
LS1 to LS4 items
TI title
BP1 to BP3 base points
PP1 to PP3 previous positions
CP1 to CP3 current positions

### DESCRIPTION OF EMBODIMENTS

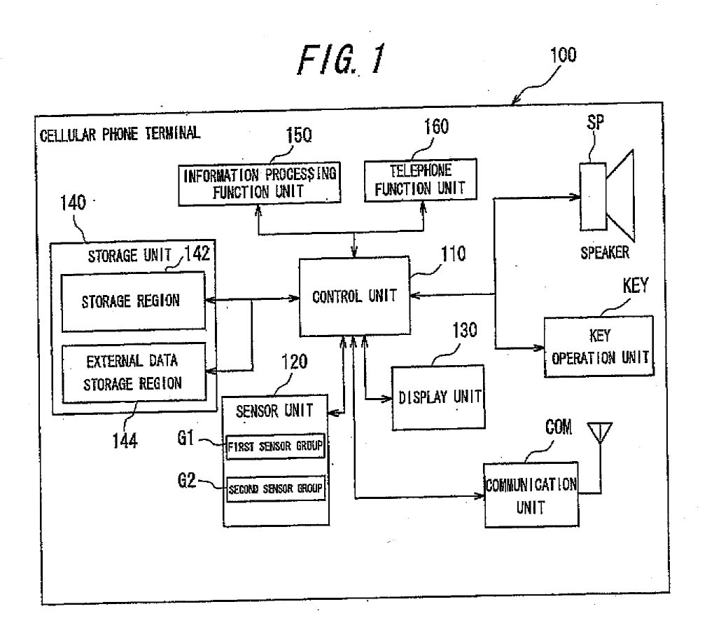

An embodiment of the present invention will be described with reference to the drawings. The present invention is applied to a cellular phone terminal as a typical example of a portable electronic apparatus in the description below. FIG. 1 is a block diagram of a basic configuration of a cellular phone terminal according to the embodiment of the present invention. The cellular phone terminal 100 is constituted by a control unit 110, a sensor unit 120, a display unit 130, a storage unit (flash memory or the like) 140, an information processing function unit 150, a telephone function unit 160, a key operation unit KEY, a speaker SP, and a communication unit COM that is connected to a CDMA communication network not shown for communication. The sensor unit 120 further includes a first sensor element group G1 and a second sensor element group G2, each having a plurality of sensor elements (for example, contact sensors that detect contact/closeness of an object such as finger, in which the detectors are arranged on the outer surface of the apparatus case). The storage unit 140 is constituted by a storage region 142 and an external data storage region 144. It is preferable that the control unit 110 and the information processing function unit 150 are constituted by calculating means, such as a CPU, software modules, and the like. A serial interface unit SI, an RFID module RFID and an infrared-ray communication unit IR connected to the control unit 110 through the serial interface unit SI, as well as a camera 220 and a light 230, in addition to a microphone MIC, a radio module RM, a power supply PS, a power supply controller PSCON, and so forth described below that are connected to the control unit 110 are omitted herein for simplification of the drawing.

The control unit 110 detects contact of an object, such as by a finger of the user, by the sensor unit 120, stores the detected information in a storage region 142 of the storage unit 140, and controls processing of the stored information by the information processing function unit 150. The control unit 110 then displays information corresponding to the processing result on the display unit 130. The control unit 110 further controls the telephone function unit 160, the key operation unit KEY, and the speaker SP for a normal call function. The display unit 130 includes a sub display unit ELD and a main display unit not shown (display unit arranged at a position that is hidden when the cellular phone terminal 100 is in a closed state and exposed in an opened state).

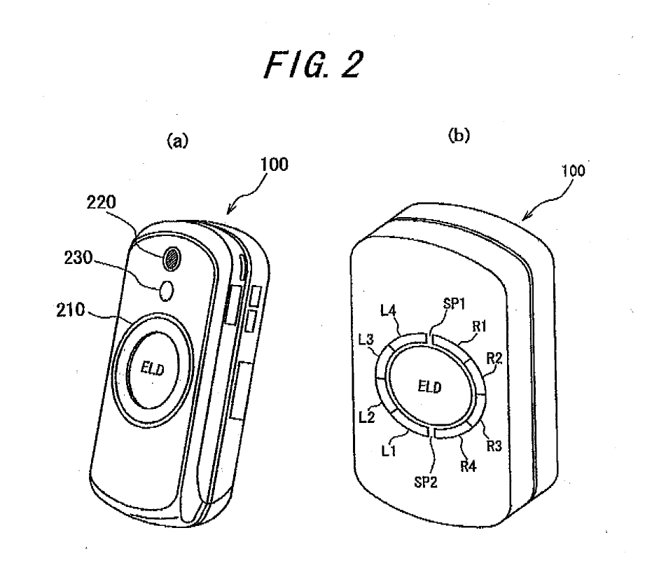

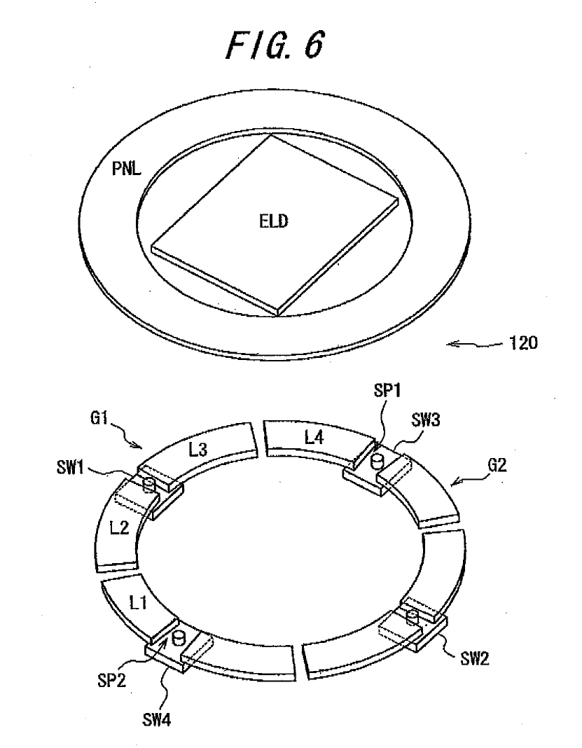

FIG. 2 shows an external appearance of the cellular phone terminal according to the present embodiment. FIG. 2(a) is an overall perspective view. FIG. 2(b) is a perspective view in which a panel PNL is omitted, and only an arrangement around the sensor elements and the sub display unit ELD is illustrated for explaining an operation of the sensor unit 120. The cellular phone terminal 100 comprises the sensor unit 120 (the panel PNL described in FIG. 6 that covers the sensor unit 120, or the sensor element groups G1 and G2, can be seen from outside), the camera 220, and the light 230. In addition to the closed state as shown in FIG. 2, the cellular phone terminal 100 can form an opened state by turning and sliding the hinge, and the sensor unit 120 is arranged at a position that is operable in the closed state too.

The sensor elements L1 to L4 and R1 to R4 are made of electrostatic capacitance contact sensors and are circularly lined up and arranged along the periphery of the sub display unit ELD made of an organic EL display.

The sensor elements L1 to L4 constitute the first sensor element group G1, and the sensor elements R1 to R4 constitute the second sensor element group G2. The first sensor element group G1 and the second sensor element group G2 sandwich the sub display unit ELD and are lined up and arranged in an axisymmetric layout across separation sections SP1 and SP2, the direction of selection candidate items lining up being the center line. The sub display unit ELD is not limited to an organic EL display, and for example, a liquid crystal display can also be used. The sensor elements L1 to L4 and R1 to R4 are not limited to electrostatic capacitance contact sensors, but thin-film resistance contact sensors can also be used.

In FIG. 2, the sub display unit ELD displays information in accordance with an application executed in the cellular phone terminal 100. For example, the sub display unit ELD displays titles of pieces of music that can be played when an application of a music player is executed. A set of the title of a piece of music and the artist name forms one item, or a “selection candidate item”. The user operates the sensor unit 120 as an operation input unit to change the electrostatic capacitance of the sensor elements R1 to R4 and L1 to L4 and moves an item or an operation target region displayed on the sub display unit ELD to select a title of a piece of music. If the sensor elements are lined up around the sub display unit ELD as shown in FIG. 2, the sensor unit 120 does not have to occupy a large proportion of the installment unit of the external case of the compact portable electronic apparatus, and the user can operate the sensor elements while looking at the display of the sub display unit ELD.

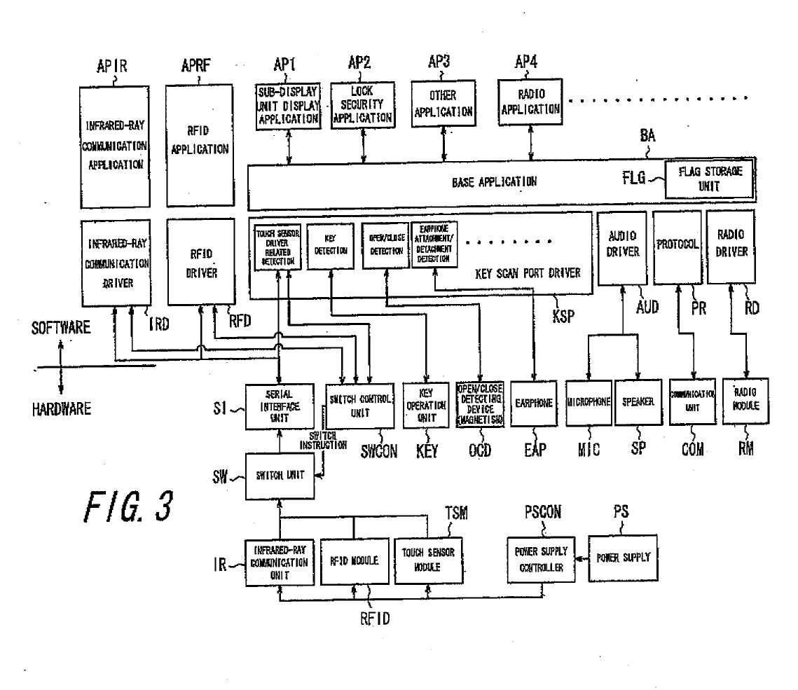

FIG. 3 is a detailed functional block diagram of the cellular phone terminal 100 according to the present embodiment. It is obvious that the control unit 110 executes and operates various software shown in FIG. 3 on a work area arranged also in the storage unit 140 based on programs stored in the storage unit 140. As shown in the figure, functions of the cellular phone terminal 100 are divided into software blocks and hardware blocks. The software blocks are constituted by a base application BA including a flag storage unit FLG, a sub display unit display application AP1, a lock security application AP2, other applications AP3, and a radio application AP4. The software blocks further include an infrared-ray communication application APIR and an RFID application APRF. An infrared-ray communication driver IRD, an RFID driver RFD, an audio driver AUD, a radio driver RD, and a protocol PR are used as drivers for the various applications to control various hardware of the hardware blocks. For example, the audio driver AUD, the radio driver RD, and the protocol PR control the microphone MIC, the speaker SP, the communication unit COM, and the radio module RM. The software blocks further include a key scan port driver KSP that monitors and detects the operation state of the hardware and performs a touch sensor driver-related detection, a key detection, an open/close detection for detecting open/close of a flip-type or a slide-type cellular phone terminal, an earphone attachment/detachment detection, and other detections.

The hardware blocks are constituted by the key operation unit KEY that includes various buttons and the like such as dial keys and tact switches SW1 to SW4 described below, an open/close detecting device OCD that detects open/close based on an operation condition of the hinge or the like, the microphone MIC provided on the apparatus main body, removable earphones EAP, the speaker SP, the communication unit COM, the radio module RM, the serial interface unit SI, and a switch control unit SWCON. According to an instruction from a relevant block of the software blocks, the switch control unit SWCON selects one of the infrared-ray communication unit IR, the RFID module (radio frequency identification tag) RFID, and a touch sensor module TSM (a set of components required to drive the sensor unit 120 and the sensor unit 120 such as an oscillator circuit is modularized) that constitutes the first sensor element group G1 and the second sensor element group G2 and switches the selection hardware (IR, RFID, and TSM) so that the serial interface unit SI picks up the signal. The power supply PS supplies power to the selection hardware (IR, RFID, and TSM) through the power supply controller PSCON.

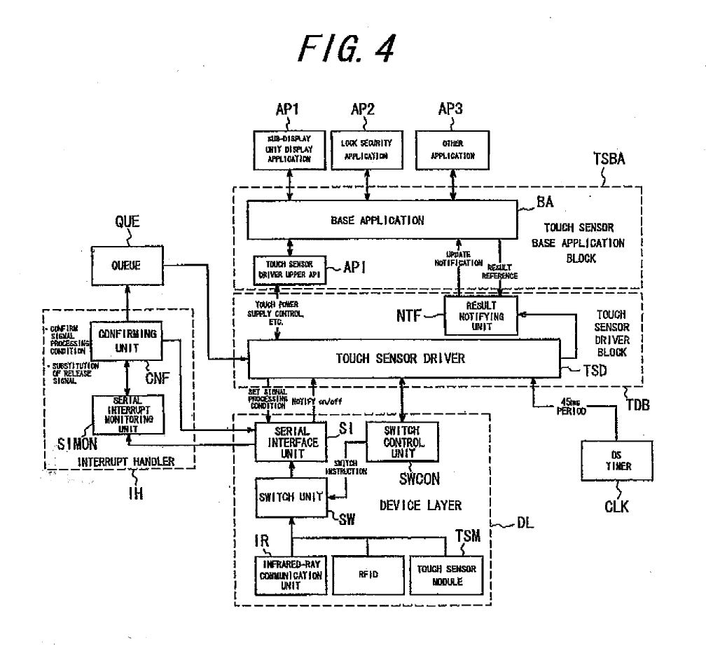

FIG. 4 is a block diagram of a more detailed constitution of the touch sensor function of the cellular phone terminal 100 according to the present embodiment. The cellular phone terminal 100 comprises a touch sensor driver block TDB, a touch sensor base application block TSBA, a device layer DL, an interrupt handler IH, a queue QUE, an OS timer CLIC, and various applications AP1 to AP3. The touch sensor base application block TSBA comprises a base application BA and a touch sensor driver upper application interface API, and the touch sensor driver block TDB comprises a touch sensor driver TSD and a result notification unit NTF. The device layer DL comprises the switch control unit SWCON, the switch unit SW, the serial interface unit SI, the infrared-ray communication unit IR, the RFID, and the touch sensor module TSM, and the interrupt handler IH comprises a serial interrupt monitoring unit SIMON and a confirming unit CNF.

Functions of the blocks will be described. In the touch sensor base application block TSBA, an exchange of whether to activate the touch sensor module TSM is made between the base application BA and the touch sensor driver upper application interface API. The base application BA is an application that serves as a basis of the sub display unit display application API that is an application for the sub display unit, a lock security application AP2 that is an application for locking the cellular phone terminal 100 to protect security of billing services using the RFID, and the other application AP3. When the applications request the base application BA to activate the touch sensor, the base application BA requests the touch sensor driver upper application interface API to activate the touch sensor module TSM. The sub display unit is the sub display unit ELD shown in figures and is disposed at the center area of the circularly arranged sensor element groups in the cellular phone terminal 100 in the present embodiment.

After receiving the request for activating the touch sensor module TSM, the touch sensor driver upper application interface API checks a block (not shown) that manages the activation of the application in the base application BA whether the activation of the touch sensor module TSM is possible. Specifically, the touch sensor driver upper application interface API checks the lighting of the sub display unit ELD indicating that an application is selected, or checks the existence of a flag indicating the activation of an application, such as FM radio or other applications included in the cellular phone terminal 100, in which the activation of the touch sensor module TSM is previously set impossible. As a result, if the activation of the touch sensor module TSM is determined possible, the touch sensor driver upper application interface API requests the touch sensor driver TSD to activate the touch sensor module TSM. Therefore, the touch sensor driver upper application interface API substantially starts supplying a power supply from the power supply PS to the touch sensor module TSM through the power supply controller PSCON.

When the activation of the touch sensor module TSM is requested, the touch sensor driver TSD requests the serial interface unit SI in the device layer DL to control to open the port with the touch sensor driver TSD in the serial interface unit SI.

Subsequently, the touch sensor driver TSD controls to output signals (hereinafter referred to as “contact signals”) including information of the sensing result of the touch sensor module TSM to the serial interface unit SI with a period of 20 ms by the internal clock included in the touch sensor module TSM.

The contact signals are outputted in 8-bit signals corresponding to eight sensor elements L1 to L4 and R1 to R4, respectively. Specifically, the contact signal is element identification information in which, when any of the eight sensor elements L1 to L4 and R1 to R4 detects contact, “flag:1” indicating the contact detection is set to the bit corresponding to the sensor element that has detected the contact. Thus, the contact signal includes information indicating “which sensor element” is “either contact/non-contact”.

The serial interrupt monitoring unit SIMON in the interrupt handler IH extracts contact signals outputted to the serial interface unit SI. The confirming unit CNF checks True/False of the extracted contact signals according to conditions preset in the serial interface unit SI and puts only True signal data into the queue QUE (types of True/False of signal will be described below). The serial interrupt monitoring unit SIMON also monitors other interrupt events of the serial interface unit SI during the activation of the touch sensor module TSM, such as pressing of a tact switch in the touch sensor module TSM described below.

The monitor unit SIMON is in a “released state” (first state) when none of the eight sensor elements L1 to L4 and R1 to R4 are detecting contact. When a first contact is detected in the released state, the monitor unit SIMON puts into the queue QUE (queues) a signal, which implies pressing, before the contact signals (element identification information). The contact signals are then updated with a period of 45 ms by clocking of the OS timer CLK included in the operation system. The monitor unit SIMON is in a “pressed state” (second state) if any of the sensor elements detects contact. The “first contact” indicates an event of a generation of a signal including “flag:1” indicated when there is no data in the queue QUE or the latest input data is released. Subsequently, when a contact signal indicating none of the sensor elements has detected contact is obtained, the released state is set according to the contact detection mode, and a signal implying the released state is put into the queue QUE. As a result, the touch sensor driver TSD can recognize the detection states of the sensor elements in the intervals from the start of contact (pressing) to the release.

In the present embodiment, the contact detection mode includes a “circular detection mode” as a first contact detection mode, in which both of the first sensor element group G1 and the second sensor element group G2 are used to perform a first control by regarding the circularly arranged sensor elements L1 to L4 and R1 to R4 as one sensor element group, and an “half-turn detection mode” as a second contact detection mode, in which the first sensor element group G1 and the second sensor element group G2 are independently used to perform a second control.

In the “circular detection mode”, after the transition from the released state to the pressed state, if a contact signal indicating none of the sensor elements has detected contact is obtained, a “release standby state” is set for a certain time (for example, 100 ms) from that point. If a contact signal indicating that any of the sensor elements has detected contact within the certain time is obtained, it is determined that a series of input operations are performed, and the pressed state is restored. The contact signal is treated to be continuous with the last contact signal in which the contact is not detected. If the contact signal is not obtained, release information is input into the queue QUE, and the state is changed to the released state. Thus, the interrupt handler IH and the queue QUE constitute buffering means in the present embodiment. In the “half-turn detection mode”, after the transition from the released state to the pressed state, if a contact signal indicating none of the sensor elements has detected contact is obtained, a signal implying the released state is put into the queue QUE at that point, and the state is changed to the released state. The “circular detection mode” and the “half-turn detection mode” are selectively applied according to the executed application, and the details will be described below.

In the “circular detection mode”, if the contact signal outputted from the touch sensor module TSM is a signal satisfying a condition of False, the monitor unit SIMON artificially generates release information and puts the release information into the queue QUE, and the monitor unit SIMON is changed to the “released state”. The conditions for setting False include “when two discontinuous sensor elements detect contact”, “when an interrupt occurs during the activation of the touch sensor module TSM (for example, when lighting/light-out state of the sub display unit ELD is changed by a notification of mail reception or the like)”, “when a key is pressed during the activation of the touch sensor module TSM”, and the like.

If, for example, two adjacent sensor elements such as the sensor elements R2 and R3 detect contact at the same time, the monitor unit SIMON puts a contact signal (element identification information), in which a flag is set to the bit corresponding to the element that has detected contact, into the queue QUE, as in the case where a single element has detected contact.

The touch sensor driver TSD reads out the contact signals from the queue QUE with a period of 45 ms and determines the element that has detected contact based on the read-out contact signals. The touch sensor driver TSD considers the change in the contact determined based on the contact signals sequentially read out from the queue QUE and the positional relationship with the detected element to determine “contact start element”, “moving direction (clockwise/counterclockwise) of contact”, and “movement distance from pressing to releasing”. The touch sensor driver TSD writes the determined result in the result notification unit NTF and notifies the base application BA to update the result.

When the touch sensor driver TSD updates the determination result, the base application BA checks the result notification unit NTF and notifies the content of the information notified to the result notification unit NTF to an application (such as the sub display unit display application AP1 for displaying a menu screen on the sub display unit and the lock security application AP2 for the lock control) that is a further upper application and that requires the contact operation result of the touch sensor module TSM.

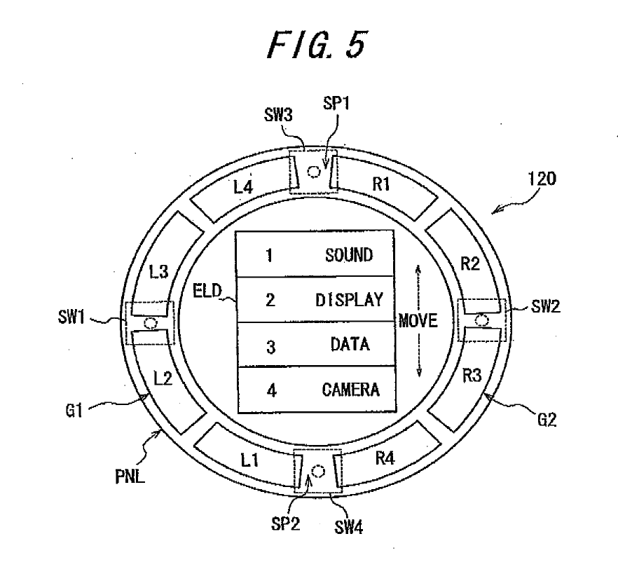

FIG. 5 is a plan view showing arrangements of constituent elements of the cellular phone terminal 100, especially of the sensor unit 120 and the sub display unit ELD, according to the present embodiment. Only unit of the constituent elements are illustrated and described for convenience of drawing and explaining. As shown in the figure, the circular panel PNL is arranged along the periphery of the sub display unit ELD made of organic EL elements. It is preferable that the panel PNL be sufficiently thin so that the sensitivity of the sensor elements arranged below is not affected. Below the panel PNL, eight electrostatic capacitance sensor elements L1 to L4 and R1 to R4 that can detect contact/closeness of the finger of human body are substantially circularly arranged. Four sensor elements L1 to L4 on the left side constitute the first sensor element group G1, and four sensor elements R1 to R4 on the right side constitute the second sensor element group G2, respectively. Clearances (gaps) are set and arranged between adjacent sensor elements in each sensor element group to prevent the adjacent sensor elements to interfere the contact detection functions of each other. The clearances are unnecessary if sensor elements of the type without the interference are used.

A separation section SP1 that is a clearance larger than the clearances between adjacent sensor elements in the same sensor element group (for example, twice the length or more) is arranged between the sensor element L4 positioned at one end of the first sensor element group G1 and the sensor element R1 positioned at one end of the second sensor element group G2. Similarly, a separation section SP2 similar to the separation section SP1 is arranged between the sensor element L1 positioned at the other end of the first sensor element group G1 and the sensor element R4 positioned at the other end of the second sensor element group G2. Arranging the separation sections SP1 and SP2 can prevent the mutual interference by the finger when the first sensor element group G1 and the second sensor element group G2 are separately functioned.

The center of the tact switch unit SW1 is arranged below the center unit of the first sensor element group G1, or below the middle of the sensor elements L2 and L3, and similarly, the center of the tact switch unit SW2 is arranged below the center unit of the second sensor element group G2, or below the middle of the sensor elements R2 and R3 (see FIG. 6). The tact switches SW3 and SW4 are arranged between the first sensor element group G1 and the second sensor element group G2, or between the sensor element L4 and the sensor element R1 and between the sensor element R4 and the sensor element L1, respectively.

Arranging the tact switches SW1 and SW2 at the substantial centers, which are positions in which the directionality is not sensed, in the arrangement direction of the sensor element groups allows the user to easily understand that the switches are for operations not directly related to an instruction of direction by the user's movement instruction operation with the directionality of finger on the sensor elements. Thus, if the tact switches are arranged at the ends (for example, L1 and L4), not the centers, in the arrangement directions of the sensor element groups, the end-direction directionality is sensed, which easily misleads the user that “switches” are long-pressed to continue the moving operation by the sensor elements. On the other hand, if the tact switches are arranged at the centers in the arrangement direction of the sensor element groups as in the present embodiment, such a misconception can be prevented, and a more comfortable user interface can be provided. Furthermore, the tact switches are arranged below the sensor elements and are not exposed to the apparatus outer surface. Therefore, the number of operation units exposed as seen from outside the apparatus can be reduced, giving an impression that the apparatus is compact so that complicated operations are not required. Additional through-holes need to be arranged on the apparatus case to arrange the switches at places other than below the panel PNL. However, the case strength may be reduced depending on the positions of the through-holes. In the present configuration, the tact switches are arranged below the panel PNL and the sensor elements, so that the arrangement of new through-holes is not required, and the reduction in the case strength can be prevented.

For example, if the user sequentially and circularly traces the sensor elements L1, L2, L3, and L4 upward with finger when the sub display unit display application API for displaying the menu screen on the sub display unit ELD is executed, items displayed as selection target regions (such as reversing display or highlight with another color) among the selection candidate items (sound, display, data, and camera in this case) displayed on the display unit ELD are sequentially changed to the ones above, or the selection candidate items scroll upward. When a desired selection candidate item is displayed as a selection target region, the user can press the tact switch SW1 over the panel PNL and the sensor elements L2 and L3 for selection and determination, or press the tact switch SW2 to change the display itself to another screen.

Arranging the tact switches SW3 and SW4, which are electronic components other than the sensor elements, between the first sensor element group G1 and the second sensor element group G2 can attain the efficient use of space and contribute to the miniaturization of the entire apparatus. The tact switch SW3 can be used as, for example, a switch for executing the sub display unit display application API or as a switch for moving the selection target region displayed on the sub display unit ELD one upward. The tact switch SW4 can be used as, for example, a cancel key or as a switch for moving the selection target region displayed on the sub display unit ELD one downward.

The panel PNL also serves as a plunger of the tact switches SW1 to SW4, the plunger being flexible enough to press the tact switches SW1 to SW4 or being slightly bendable and attached to the apparatus case.

FIG. 6 is an exploded perspective view of constituent elements of the cellular phone terminal 100, especially the sensor unit 120, shown in FIGS. 2 and 5. As shown in the figure, the panel PNL and the sub display unit ELD are arranged on a first layer constituting the outer surface of the terminal case. The sensor elements L1 to L4 and R1 to R4 are arranged on a second layer positioned below the panel PNL of the first layer. The tact switches SW1, SW2, SW3, and SW4 are arranged on a third layer located between and below the sensor elements L2 and L3 of the second layer, between and below the sensor elements R2 and R3, between and below the sensor elements L4 and R1, and between and below the sensor elements R4 and L1, respectively.

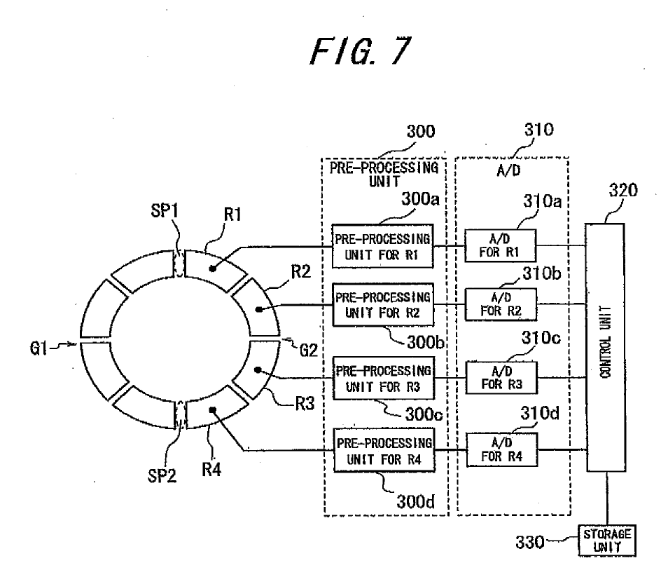

FIG. 7 is a schematic block diagram for explaining processing of contact detection data from each sensor element. Although only the sensor elements R1 to R4 are illustrated for simplification of explanation, the same applies to the sensor elements L1 to L4. A high-frequency wave is applied to each of the sensor elements R1 to R4. A pre-processing unit 300 (pre-processing unit 300a for R1, pre-processing unit 300b for R2, pre-processing unit 300c for R3, and pre-processing unit 300d for R4) calibrates each of the sensor elements R1 to R4 in consideration of the change in a certain stray capacitance, sets the high frequency state at that point as a reference, and detects the fluctuation of the high frequency state based on the change in the electrostatic capacitance due to contact by finger or the like. A detection signal by the pre-processing unit 300 is transmitted to an A/D converter 310 (A/D converter 310a for R1, A/D converter 310b for R2, A/D converter 310c for R3, and A/D converter 310d for R4) and converted to a digital signal indicating the contact detection. The digitalized signal is transmitted to the control unit 320 and combined to a signal of other elements L1 to L4 to obtain an 8-bit contact signal. The 8-bit contact signal is converted to, for example, hexadecimal and stored in a storage unit 330. Subsequently, the control signal is transmitted to a serial interface unit and an interrupt handler, and the interrupt handler converts the control signal to a signal readable by the touch sensor driver, and the converted signal is put into the queue. Based on the information stored in the storage unit 330, the control unit 320 detects the direction when two or more adjacent sensor elements detect contact.

The “circular detection mode” as a first contact detection mode and the “half-turn detection mode” as a second contact detection mode of the cellular phone terminal 100 of the present embodiment will now be described.

The “half-turn detection mode” will be described first. The “half-turn detection mode” is for detecting the moving direction and the movement distance of the contact operation in the sensor unit 120 to select an item displayed on the sub display unit ELD when the application of the music player, the sub display unit display application API, or the like is executed. As described, in the “half-turn detection mode”, if a contact signal indicating none of the sensor elements has detected contact is obtained after the monitor unit SIMON has changed from the “released state” (first state) to the “pressed state” (second state), the monitor unit SIMON is changed to the released state at that point, and the touch sensor driver TSD detects the detection states of the sensor elements in the interval from the pressed state to the released state.

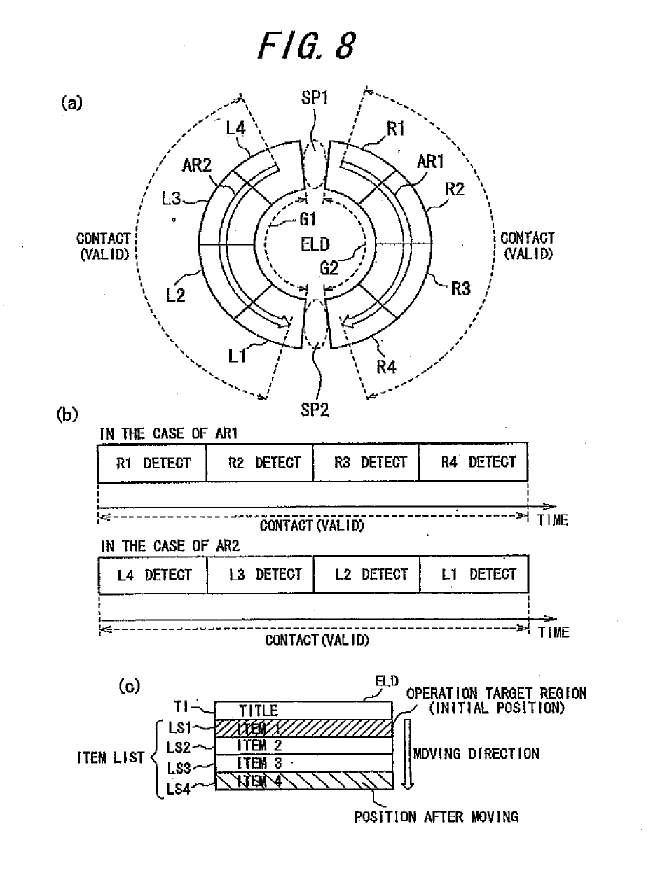

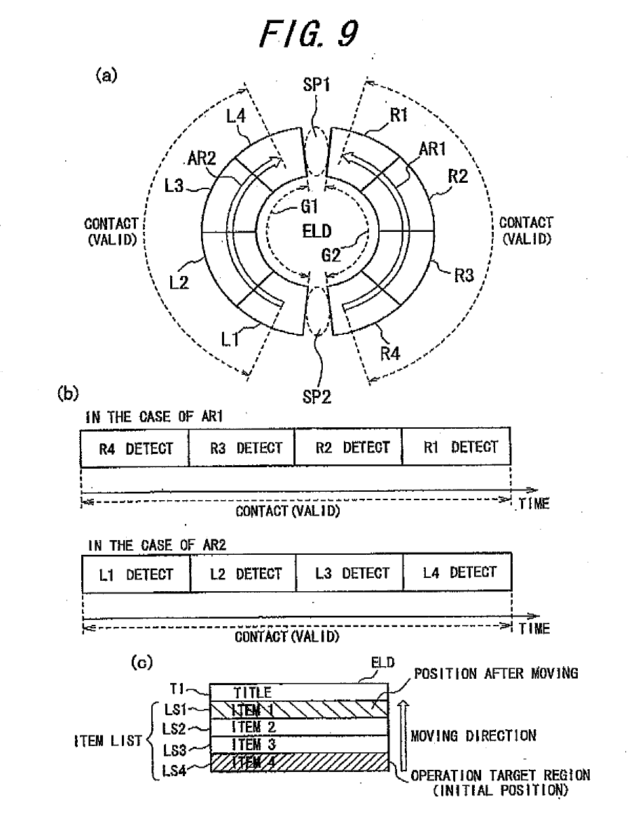

FIGS. 8 and 9 are diagrams for explaining an example of the “half-turn detection mode” and depict an operation of the sub display unit when the user traces the sensor elements. In FIGS. 8 and 9, (a) depict schematic diagrams showing only the sub display unit mounted on the cellular phone terminal and the sensor elements lined up and arranged along the periphery of the sub display unit for simplification of description, (b) depict the sensor elements detected along the time transition, and (c) depict positional changes of the operation target region of the sub display unit ELD according to the detected sensor elements. In FIGS. 8(a) and 9(a), the same reference numerals as in FIG. 2(b) are designated to the sensor elements, the sensor element groups, and the separation sections. In the display of the sub display unit ELD of FIGS. 8(c) and 9(c), TI denotes a title of an item list displayed by the sub display unit, and LS1 to LS4 denote selection candidate items (for example, several rows that can be scrolled). In the sub display unit of FIGS. 8(c) and 9(c), the cursor is arranged at the item to be operated, or the item is highlighted by reversing display or the like to allow identifying the current operation target region. In FIGS. 8 and 9, the item displayed as the operation target region is emphasized by hatching. Although the “object to be moved” will be described only with the operation target region for convenience of explanation, the sub display unit is operated in the same principle when the item itself is moved (scrolled).

If the sensor elements are continuously traced using contact means such as finger from top to bottom as shown with an arrow AR1 in FIG. 8(a), the control unit detects contact in a time transition shown in FIG. 8(b). In this case, the contact is detected in order of sensor elements R1, R2, R3, and R4. The continuous contact from R1 to R4 is detected in two or more adjacent sensor elements. Therefore, the direction detected, and the operation target region is moved on the list displayed on the sub display unit ELD according to the times of transitions in the adjacent sensor elements and the direction. In this case, as shown in FIG. 8(c), the operation target region is moved three items downward from the initial position item LS1 to the item LS4. The operation target region is hatched in the illustration, and the narrow hatching pitch illustrates an initial position, while the wide hatching pitch illustrates a position after the movement. According to the present configuration, the “operation target region moves downward” in the sub display unit in the same way as the user's “downward instruction motion of finger”. Therefore, the user feels as if the user commands the movement of the operation target region with the user's finger. In other words, the user's intended operability can be obtained.

Similarly, if the sensor elements are traced in the arrow AR2 direction in FIG. 8(a), the sensor elements L4, L3, L2, and L1 among the sensor elements detect contact in that order as shown in FIG. 8(b). In this case, as in the case of the arrow AR1, the contact moves three adjacent sensor elements from top to bottom. Therefore, as shown in FIG. 8(c), the operation target region is moved three items downward from the item LS1 to the item LS4.

If the sensor elements are traced in the direction from bottom to top (counterclockwise) as shown with the arrow AR1 in FIG. 9(a), the sensor elements R4, R3, R2, and R1 among the sensor elements detect contact in that order, as shown in FIG. 9(b). In this case, the contact moves three adjacent sensor elements from bottom to top. Therefore, as shown in FIG. 9(c), the operation target region is moved three items upward from the item LS4 to the item LS1.

Similarly, if the sensor elements are traced in the direction from bottom to top (clockwise) shown with the arrow AR2 in FIG. 9(a), the sensor elements L1, L2, L3, and L4 among the sensor elements detect contact in that order, as shown in FIG. 9(b). In this case, the contact moves three adjacent sensor elements from bottom to top as in the case of the arrow AR1. Therefore, as shown in FIG. 9(c), the operation target region is moved three items upward from the item LS4 to the item LS1.

As described, in the “half-turn detection mode”, contact to only one sensor element (for example, R2) is not detected as a movement in each sensor element group. Only after the contact moves from the sensor element to an adjacent sensor element (for example, R3), the contact is detected as a movement for an amount of one element (amount of one item in the sub display unit ELD) in that direction. Therefore, a contact transition between two adjacent sensor elements across the separation section SP1 or SP2, or a contact transition between L4 and R1 or a contact transition between L1 and R4, is determined invalid and not detected as a movement.

Even in the contact transition across the separation section SP1 or SP2, if there is a transition between adjacent sensor elements within the same sensor element group, the contact transition in the sensor element group is determined valid and is detected as a movement in the contact transition direction. Therefore, if, for example, the contact moves R3→R4→L1, the transition of R3→R4 is determined valid, and the transition of R4→L1 is determined invalid. The operation target region would be moved one item downward in the sub display unit ELD. If the contact moves from R1 to L4 clockwise, the transition from R1 to R4 is determined valid, the transition of R4→L1 is determined invalid, and the transition from L1 to L4 is determined valid. The operation target region moves three items downward in the sub display unit ELD and then moves three items upward to return to the original position.

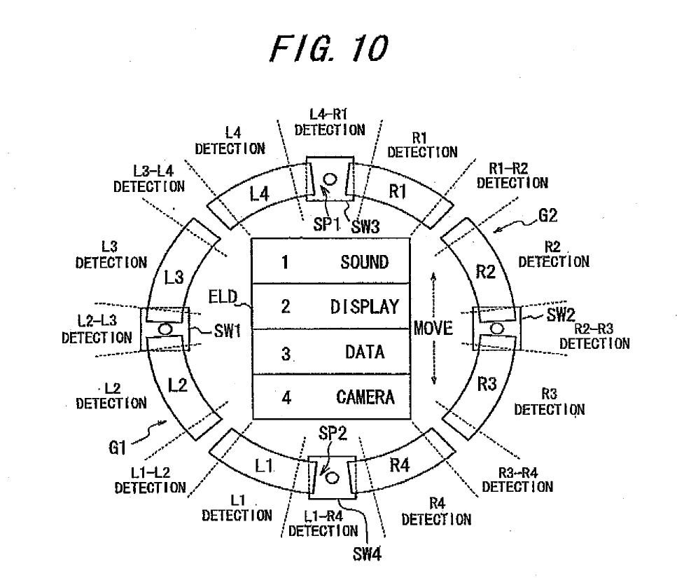

FIG. 10 is a schematic diagram for explaining another example of the “half-turn detection mode”. In the example, the sensor element detection state is divided into sixteen detection states to determine not only the single element detection state of the sensor element detection state, but also the plurality of elements detection state in which two adjacent elements are further detected. The tact switches SW1 to SW4 are also illustrated herein, as in FIG. 5.

As shown in FIG. 10, the control unit 110 can manage sixteen detections in total, R1 detection, R2 detection, R3 detection, R4 detection, L1 detection, L2 detection, L3 detection, and L4 detection in which only a single sensor element detects contact, as well as R1-R2 detection, R2-R3 detection, R3-R4 detection, L1-R4 detection, L1-L2 detection, L2-L3 detection, L3-L4 detection, and L4-R1 detection for detecting contact of two adjacent sensor elements. Thus, in the “half-turn detection mode”, sixteen sensor element detection states are set to allow detecting single element detection states, in which the operation state of only one sensor element is detected, and adjacent element detection states, in which operation states of two adjacent sensor elements are detected, thereby allowing more precise control.

When the control unit 110 manages the detection states of eight sensor elements one by one, the control unit 110 can manage eight detection states. However, not much precise control can be performed with eight detection states, because the number of states, or state changes, is small. Furthermore, in a portable electronic apparatus that requires portability, the sensor elements may be touched across sensor elements because the sizes of the sensor elements are also small. In that case, if, for example, contact is detected in the order of the sensor elements L2 and L3, an upward movement instruction is set, and an operation against the user's intension may be performed. In order to properly process the detection of contact to the sensor elements, the confirmation of the movement instruction needs to be suspended until two or three detection state changes (movements) are detected in sixteen detection states. The process of suspending the confirmation of the movement instruction will be described in detail below with reference to a flow chart.

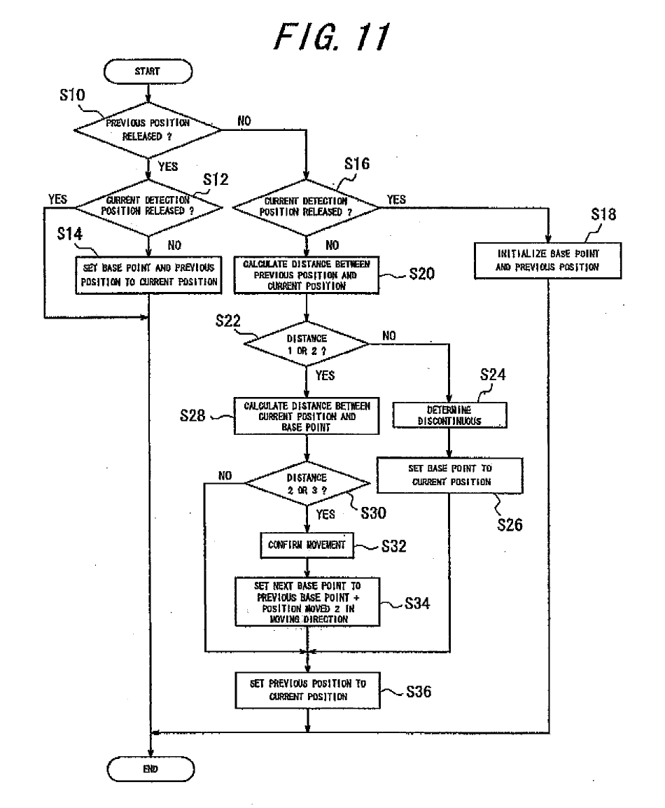

FIG. 11 is a flow chart of an example of the movement fixing processing (or suspending process) in sixteen detection states. The touch sensor driver TSD executes the process shown in the flow chart every time an occurrence of any one of the detection states in the queue QUE is detected. The initial base point is set to a position detected first from the released state (one of sixteen detection states). The movement distance (transition of detection state) is determined from three positions, the base point, the current detection position (new detection state inputted to the queue QUE), and the previous detection position (detection state before this one remaining in the queue QUE). As shown in the figure, whether the previous position is released is determined in step S10. If the previous position is determined to be released (the previous data remaining in the queue QUE is “released”), the process proceeds to step S12, and whether the current detection position is released (or whether the newly inputted data is “released”) is determined. If the current detection position is determined to be released, the process ends, and if not, the process proceeds to step S14, and the base point and the previous detection position are set to the current detection position.

If it is determined that the previous position is not released (or another detection is made, and the current detection is a continuation of the detection) in step S10, the process proceeds to step S16, and whether the current detection position is released (or the newly inputted signal is “released”) is determined. If the current detection position is determined to be released, the base point and the previous detection position are initialized (cleared), and the process ends (step S18). If it is determined that the current detection position is not released in step S16, the distance between the previous detection position and the current detection position is calculated (step S20), and whether the calculated distance is 1 or 2 is determined (step S22). If it is determined that the calculated distance is not 1 or 2, it is determined as a discontinuous detection state with skipped sensor elements (step S24), and the base point is set to the current detection position before proceeding to skip S36. If the distance calculated in step S22 is determined to be 1 or 2, the distance between the current detection position and the base point is calculated (step S28). Since the detection position of each sensor element can be recognized from the signals inputted to the queue QUE, the touch sensor driver TSD determines a difference of how many detection states is there between the previous detection position and the current detection position among sixteen detection states to calculate the distance.

Furthermore, whether the distance calculated in step S28 is 2 or 3 is determined (step S30). If the condition is not satisfied (thus, 4 or more), the process proceeds to step S36 as an error. If the condition is satisfied (when the distance is 2 or 3), the movement is confirmed (step S32). Thus, the first touched position is set as the “base point”, and then the “previous position” is updated when the contact is continued to be detected without being “released” thereafter. Eventually, it is determined that “there is a movement” only after the “current position”, which is the latest detection position, is determined “to have been moved 2 or 3” relative to the base point. Furthermore, the “movement of 2” is determined after consecutively detecting the single element detection state and the plurality of elements detection state. Therefore, on the sensor elements, the finger is determined to have been moved by an amount of one sensor element only after the “movement of 2”. The next base point is set to a position moved by two in the moving direction from the previous base point (step S34), and the process proceeds to step S36. In step S36, the “previous detection position” is set to the “current detection position” for the next process, and the process ends.

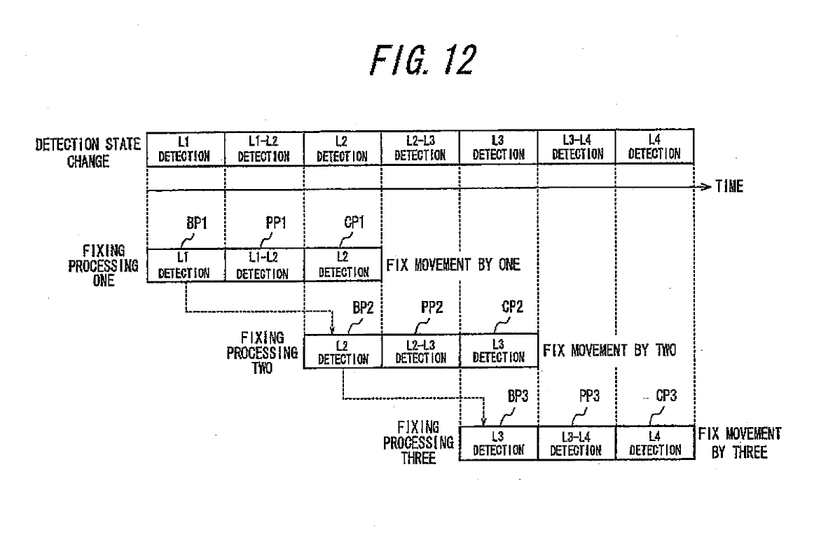

FIG. 12 is a diagram for explaining a fixing processing when the process of the flow chart of FIG. 11 is applied to the contact from the sensor elements L1 to L4 of FIG. 10. As shown in the figure, the detection state change exhibits “L1 detection”, “L1-L2 detection”, “L2 detection”, “L2-L3 detection”, “L3 detection”, “L3-L4 detection”, and “L4 detection”. Thus, the single element detection state and the plurality of elements detection state are repeatedly detected from L1 to L4. First, the first “L1 detection” is set as a base point BP1 (S14). Next, when the “L1-L2 detection” occurs, the previous position and the current position detected this time are compared (S22) since the previous position is the “L1 detection”, not the release. The movement herein is one frame from L1 to L1-L2 and is determined valid because the determination condition “1 or 2?” is satisfied. At this time, the base point and the current position are compared (S30). Since both of the base point and the previous position are set to the same L1, the amount of movement is also one frame. Therefore, the movement is not confirmed at this point, and the L1-L2 detection state of the current position is set as a previous position PP1 (S36).

If the “L2 detection” occurs without the occurrence of “release” in the middle, the previous position and a current position CP1 detected this time are compared (S22) since the previous position is the “L1-L2 detection”. The movement herein is one frame from L1-L2 to L2 and is determined valid since the determination condition “1 or 2?” is satisfied. At this time, the base point and the current position are compared (S30). The base point at this time is still set to the same L1 as in the case of the L1 detection, and the positional relationship with L2 is two frames. Therefore, the amount of movement is determined as two frames. The movement is confirmed for the first time at this point (S32). For the next determination, a base point BP2 is set to the point moved two frames in the moving direction from the “L1 detection”, i.e. the “L2 detection” (S34). The previous position is reset to the current position “L2 detection”, and the fixing processing 1 is completed (S36).

In this way, the touch sensor driver TSD detects the transition of detection state of two frames to determine the movement “1”. Thus, if the movement is confirmed in step S32, the moving direction component (clockwise from L1 to L4) and the movement of “1” are stored in the result notification unit NTF, and the update of the storage content is notified to the base application BA. The base application BA extracts the update content which is then notified to the sub display unit display application API and the like. If the sub display unit display application AP1 is in use, an amount of movement “1” is provided “in the direction from bottom to top” based on the moving direction component. Therefore, the display of the sub display unit ELD is changed as a process proportional to the amount. Specifically, if the list is displayed as shown in FIG. 8(c) and the operation target region is positioned at LS4, the operation target region is moved to LS3 based on the fixing processing 1. By the way, the touch sensor driver TSD provides information for providing “direction from bottom to top” and the amount of movement “1” based on the moving direction component to the sub display unit display application AP1 through the base application if the detection states consecutively and continuously change from the “R4 detection” state to “R4-R3 detection” and “R3 detection” in R1 to R4 that constitute the second sensor element group as in the fixing processing 1. The operation target region is changed from the item LS4 to LS3 on the screen display of the list, as in the operation in the first sensor element group.

A case that the movement of finger continues without the occurrence of “release” following the fixing processing 1 will now be described. As in the case of the fixing processing 1, the detection state advances two frames from a base point BP2 as shown in a fixing processing 2 in FIG. 12, and the “L2-L3 detection” is set as a previous position PP2. When the “L3 detection” is at a current position CP2, the distance between the base point BP2 and the current position CP2 is two frames. Therefore, a movement “1” is further confirmed. Therefore, a total movement of “2” is confirmed by both of the fixing processing 1 and the following fixing processing 2. The “L3 detection” two frames forward from the base point BP2 “L2 detection” is set as a new base point BP3 to change the base point for the following processes.

Similarly, as shown in a fixing processing 3 in FIG. 12, the detection state advances two frames from the base point BP3, and the “L3-L4 detection” is set as a previous position CP3. When the “L4 detection” is at the current position CP3, the distance is two frames. Therefore, a movement of “1” is further confirmed. Combining with the fixing processing 1 and the fixing processing 2, a total of “3” movements are confirmed. In this way, the total “3” movements are notified to the application.

The movement confirmation of “1” in the “direction from bottom to top” is notified twice to the sub display unit display application AP1 for display on the sub display unit ELD following the fixing processing 1. Therefore, the operation target region is moved and changed “2” upward from LS3 to LS1. Although the detection states are divided with a configuration for detecting not only the single element detection states but also the plurality of elements detection state, the movement confirmation of up to “3” is eventually performed when the sensor elements are constituted by four sensor elements as in the example, because the amount of movement confirmed by the movement of two frames of state transition is “1”. Therefore, the eventual visual amount of movement is highly similar to the case of confirming the movement only by the signal element detection with four sensor elements. Up to “3” amount of movement can be secured even if not only directly above the single elements are accurately touched. Therefore, there is no situation without a reaction to a user's inaccurate operation, and a user's desired format can be attained.

When the user carrying a cellular phone operates the cellular phone at a location susceptible to vibrations, the finger may be departed from the sensor unit 120 for a moment during the movement of the finger due to external vibrations. In such a case, although a detection failure is less likely to occur with a rough detection method of detecting movement by performing single element detections of detecting only for the number of sensor elements, if a precise detection method of detecting not only the single element detection state but also detecting a plurality of elements detection state is implemented, one detection state may be skipped because the finger is continuing the rotation operation even if the finger is momentarily departed. However, because “the distance between the previous position and the current position is 1 or 2?” is set in step S22, the movement of 2 from the previous position, or 1 skip from the previous position, can be handled as a continuous movement detection state. Therefore, an operation as close as possible to the user's intention can be performed even in vibrations.

The moving operation can be detected even if the finger is departed for a moment due to vibrations or the like or if one detection state is skipped and detected with a quick operation, because not only the distance of two frames but also of three frames are valid in step S30. Furthermore, in the three frame movement detection, not only is the amount of movement “1” is confirmed as in the case of the next two frames, but also the base point for the next detection is only moved for two frames relative to the previous base point as in the case of the two frame movement. Therefore, when the movement is confirmed by the three frame detection, the movement confirmation of “n−1”, which is the number of sensor elements n minus 1, can be obtained. As a result, the user can obtain the same and stable operability regardless of the way the user touches the elements.

In this way, the single element detection state of detecting the operation state of only one of the plurality of sensor elements and the adjacent element detection state of detecting operation states of two adjacent sensor elements among the plurality of sensor elements are detected, and the movement is determined with a combination of the single element detection state and the adjacent element detection state. As a result, the user's intended operability can be obtained, and more precise movement detection can be performed without rearranging the apparatus. Furthermore, a malfunction due to simultaneous touching of two different points can be prevented, and a false detection caused by a simple touch or the influence of noise or the like can be prevented.

In case of displaying five or more selection items on the screen and the detection is performed with only four elements, several times of tracing from upper elements to lower elements by finger are needed to select the selection item at the bottom. However, in the “half-turn detection mode”, the number of times of tracing can be reduced by, for example, providing a movement of up to two frames in two elements. Therefore, an application for providing a multiplicity of movement parameters with few sensor elements is also possible.

Next, the “circular detection mode” will be described. The “circular detection mode” is for detecting the number of rotations of a contact operation and the rotation direction in the sensor unit 120 to remove the security lock during the execution of the lock security application AP2 described above, for example.

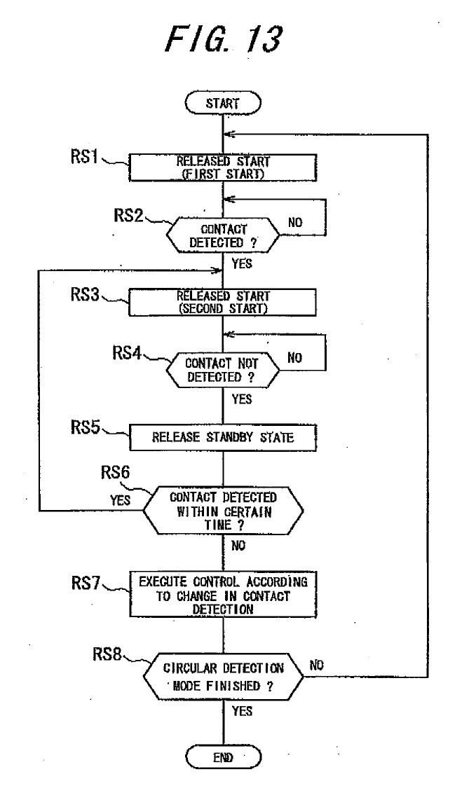

FIG. 13 is a flow chart of a basic operation of contact detection of a touch sensor in the “circular detection mode”. In the “circular detection mode”, from the “released state (first state)” (RS1), when any sensor element detects contact (RS2) and the state is changed to the “pressed state (second state)” (RS3), whether a contact non-detection, in which no sensor element detects contact, has occurred is detected (RS4), and a “release standby state” is set if the contact non-detection is detected (RS5).

Subsequently, whether any of the sensor elements has detected contact within a certain time (for example, 100 ms) after the detection of the contact non-detection in RS4 is detected (RS6). It is determined that a series of input operations are performed when the contact is detected, and the state is changed to the “pressed state (second state)” of RS3. The contact signal is treated to be continuous with the contact signal immediately before the contact non-detection in RS4. On the other hand, it is determined that a release has occurred if the contact is not detected within a certain time in RS6. The release information is put into the queue QUE, and a control according to the changes in the contact detections so far is executed (RS7). If the circular detection mode is not completed, the state is changed to the released state of RS1 (RS8).

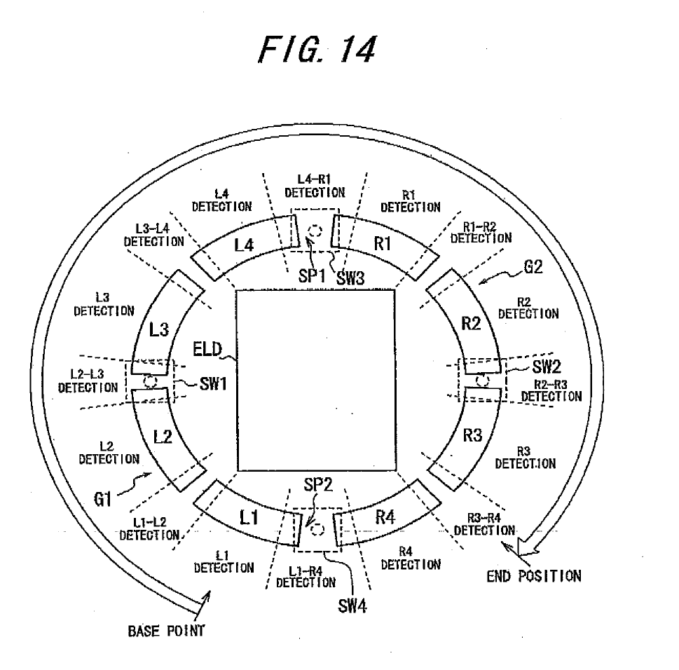

FIG. 14 is for explaining a specific example of the “circular detection mode” and is a schematic diagram in which the sensor element detection state is divided into sixteen including single sensor element detection states and a plurality of elements detection state, as in FIG. 10. In this case, one sensor element among the sensor elements L1 to L4 and R1 to R4 that are regarded as one sensor element group detects contact and, with the position of the one sensor element as a base point, detects that a plurality of sensor elements from the base point to the previous position clockwise have consecutively and sequentially detected contact within a predetermined time (for example, several seconds) to detect one clockwise rotation of contact operation. The continuous contact detections by the sensor elements L1 to L4 and R1 to R4 are detected considering the “release standby state” shown in FIG. 13.

For example, in case of detecting the clockwise rotation in FIG. 14, the base point is set to L1 if the pressed position, in which the finger has first touched from the released state, is the L1 detection position. Consecutive and sequential detections of contact from L1 to the R3-R4 detection positions including the contact detection by the previous sensor element R4 clockwise within a certain time is detected, and one clockwise rotation of contact operation is detected. Consequently, if consecutive and sequential detections of contact from L1 to the R3-R4 detection positions are still detected within a predetermined time without being released, the next one clockwise rotation of contact operation is detected. Subsequently, the same operation is repeated after the “release standby state” until the finger is released from the sensor element group.

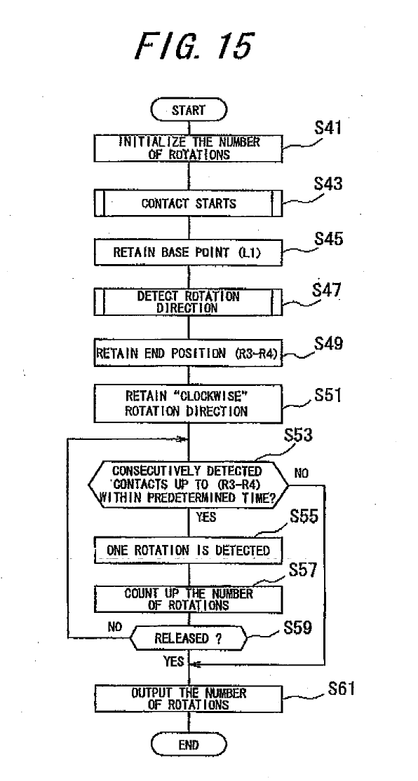

FIG. 15 is a flow chart in this case. First, if a removal process of the security lock is selected when the lock security application AP2 is executed, the number of rotations stored in the storage region 142 of the storage unit 140 shown in FIG. 1 is initialized (S41). Subsequently, if the user starts touching the sensor unit 120 (S43), the pressed position where the finger first touched is retained in the storage region 142 as a base point (start position) of rotation (S45). In this case, it is determined that the L1 detection position is first touched, and the position L1 is retained as the base point.

Subsequently, the control unit 110 detects the start of the rotation operation by the user based on the change in the contact signal read out from the queue QUE in consideration of the “release standby state” and detects the transition direction, or the rotation direction, of the contact (S47). Based on the detected rotation direction and the base point retained in step S45, the control unit determines the previous position of the base point position serving as an end point of the one-circular detection as the end position and retains the position in the storage region 142 (S49). The base point is L1, and the rotation direction is clockwise in this example. Therefore, the R3-R4 detection position including the contact detection position by the sensor element R4, which is one position before the sensor element L1 clockwise, is determined and retained as the end position R4.

Subsequently, the rotation direction in the rotation detection process is retained clockwise (S51), and whether the sensor elements have consecutively and sequentially detected contacts from the base point L1 to the R3-R4 detection position including the clockwise end position R4 within a predetermined time is detected based on the sequential changes in the contact signals read out from the queue QUE in consideration of the “release standby state” (S53). If the contacts are sequentially detected, one clockwise rotation is detected (S55), and the counter of the number of rotations is counted up (S57). Subsequently, whether the release standby state has passed and the finger is released is determined based on the contact signal (S59). The process moves to step S53 if the finger is not released, and the position L1 that is the same as the first rotation is set as the base point to detect the next clockwise rotation.

On the other hand, if the sensor elements have not consecutively and sequentially detected contacts from the base point L1 to the R3-R4 detection position including the clockwise end position R4 within the predetermined time in step S53, or if the finger is determined to be released in step S59, the count value in the counter of the number of rotations at this point is outputted (S61), and the rotation detection process ends.

Although the rotation direction is clockwise herein, the same applies to the counterclockwise. The end position of rotation is not limited to one position before the base point in the rotation direction, and may also be two or more positions before. If, for example, the pressed position touched first by the finger is the L1-L2 detection position, one of them may be preset as the base point, or the determined base point may be changed according to the rotation direction. For example, in case of the L1-L2 detection position, the base point is preset to L1. Subsequently, if the rotation direction is detected to be clockwise, the base point L1 is retained, and the end position is determined as R4 in case of the one-position-before. If the rotation direction is determined to be counterclockwise, the base point is changed from L1 to L2, and the end position is determined as L3 in case of the one-position-before. Furthermore, although the rotation is detected by monitoring sixteen sensor element detection states including the plurality of elements detection state for two adjacent sensor elements to detect contact at the same time, the rotation can also be detected by monitoring eight sensor element detection states for only single sensor elements to detect contact.

In this way, in the present embodiment, even if the finger departs from the sensor unit 120 in the “circular detection mode”, a series of input operations are determined to be performed if the finger touches the sensor unit 120 again within a certain time, and the contact signal is treated to be continuous with the contact signal immediately before the finger has departed. Therefore, when the relatively wide separation sections SP1 and SP2 formed between the first sensor element group G1 and the second sensor element group G2 are crossed over, the continuous detection state can be determined even if the contact is not detected momentarily. Unlike when the cursor or the like is moved in the “half-turn detection mode”, the rotation operation tends to be rough and quick when the finger simply traces and rotates the sensor unit 120 to remove the security lock. Therefore, the finger tends to momentarily depart or deviate from the sensor unit 120, especially when the sensor unit 120 is small. However, the continuous detection state can be set even in such a case. Similarly, the continuous detection state can be set even if the finger momentarily departs or deviates from the sensor unit 120 in the input operation in a moving environment susceptible to external vibrations. Furthermore, in the “circular detection mode”, if the contact signal outputted from the touch sensor module TSM is False, the release information is artificially generated and put into the queue QUE, or the error signal is simply replaced by the release information, to change the monitor unit SIMON to the “released state”. As a result, false detections can be simply and surely prevented. Therefore, the user's intended input operation can be always and surely reflected, the operability can be improved, and making the user uncomfortable by forcing the user to retry can be prevented.

Furthermore, in the “half-turn detection mode”, if a contact signal indicating that none of the sensor elements has detected contact after the transition from the “released state” to the “pressed state”, a transition to the released state is made at that point, and the movement is confirmed. This can provide quick operability to the user.

The present invention is not limited to the above described embodiment, and various modifications can be made without departing from the scope of the invention. For example, in the above embodiment, a “release standby state” can be set in the “half-turn detection mode” that includes a standby time different from the “release standby state” in the “circular detection mode”. The first sensor element group G1 and the second sensor element group G2 are not limited to be substantially circular, but may also be arranged in an arbitrary circular pattern, such as rectangular or polygonal. The arrangement is not limited to circular, but may also be in an arbitrary pattern, such as straight or curved, in which at least the one ends are close to each other. The number of sensor elements in each sensor element group is not limited to four, but may be an arbitrary plural number. The number of sensor element groups may also be one. Furthermore, the sensor elements are not limited to the electrostatic capacitance contact sensors or the thin-film resistance type. An optical system for detecting contact by the fluctuation in the amount of received light, an SAW system for detecting contact by the attenuation of the surface acoustic wave, or an electromagnetic induction system for detecting contact by the generation of induced current may also be used for the sensor elements. Sensor elements using instruction equipment such as a dedicated pen, instead of finger, may also be used depending on the type of the contact sensor. The present invention can be applied not only to the cellular phone terminal, but also widely to a PDA (personal digital assistance), a portable gaming apparatus, a portable audio player, a portable video player, a portable electronic dictionary, a portable electronic book viewer, and other portable electronic apparatuses.

1. A portable electronic apparatus comprising:
a first sensor group including a plurality of sensor elements that are consecutively lined up and arranged and that detect contact; and
a control unit that monitors output of the plurality of sensor elements and that executes control based on change in a sensor element that has detected contact, wherein
the control unit includes a first contact detection mode for changing from a first state, in which none of the plurality of sensor elements has detected contact, to a second state after detecting that any of the sensor elements has detected contact, changing again to the first state after detecting that a state of none of the sensor elements detecting contact in the second state has continued for a certain time, and executing control according to the change in the contact detection in the plurality of sensor elements occurred in the second state.

2. The portable electronic apparatus according to claim 1, characterized in that
the control unit includes buffering means for storing element identification information for identifying a sensor element that has detected contact based on monitoring result of the output of the first sensor element group and release information indicating that the state of none of the sensor elements detecting contact in the second state has continued for a certain time and changes to the first state or the second state based on the information stored in the buffering means.

3. The portable electronic apparatus according to claim 2, characterized in that
the buffering means stores the release information if the first sensor element group detects abnormal contact.

4. The portable electronic apparatus according to claim 1, characterized by further comprising
a second sensor element group including a plurality of sensor elements that are consecutively lined up and arranged and that detect contact, wherein
at least one ends of the first sensor element group and the second sensor element group are arranged close to each other, and
the control unit can execute a first control based on the contact detection using both of the first sensor element group and the second sensor element group in the first contact detection mode.

5. The portable electronic apparatus according to claim 2, characterized by further comprising
a second sensor element group including a plurality of sensor elements that are consecutively lined up and arranged and that detect contact, wherein
at least one ends of the first sensor element group and the second sensor element group are arranged close to each other, and
the control unit can execute a first control based on the contact detection using both of the first sensor element group and the second sensor element group in the first contact detection mode.

6. The portable electronic apparatus according to claim 3, characterized by further comprising
a second sensor element group including a plurality of sensor elements that are consecutively lined up and arranged and that detect contact, wherein
at least one ends of the first sensor element group and the second sensor element group are arranged close to each other, and
the control unit can execute a first control based on the contact detection using both of the first sensor element group and the second sensor element group in the first contact detection mode.

7. The portable electronic apparatus according to claim 4, characterized in that
the control unit can execute a second control based on contact detection using one of the first sensor element group and the second sensor element group in a second contact detection mode that is different from the first contact detection mode.

8. The portable electronic apparatus according to claim 5, characterized in that
the control unit can execute a second control based on contact detection using one of the first sensor element group and the second sensor element group in a second contact detection mode that is different from the first contact detection mode.

9. The portable electronic apparatus according to claim 6, characterized in that
the control unit can execute a second control based on contact detection using one of the first sensor element group and the second sensor element group in a second contact detection mode that is different from the first contact detection mode.

10. The portable electronic apparatus according to claim 4, characterized in that
electronic components other than the sensor elements are arranged between adjacent ends of the first sensor element group and the second sensor element group.

11. The portable electronic apparatus according to claim 5, characterized in that
electronic components other than the sensor elements are arranged between adjacent ends of the first sensor element group and the second sensor element group.

12. The portable electronic apparatus according to claim 6, characterized in that
electronic components other than the sensor elements are arranged between adjacent ends of the first sensor element group and the second sensor element group.

13. The portable electronic apparatus according to claim 7, characterized in that
electronic components other than the sensor elements are arranged between adjacent ends of the first sensor element group and the second sensor element group.

14. The portable electronic apparatus according to claim 8, characterized in that
electronic components other than the sensor elements are arranged between adjacent ends of the first sensor element group and the second sensor element group.

15. The portable electronic apparatus according to claim 9, characterized in that
electronic components other than the sensor elements are arranged between adjacent ends of the first sensor element group and the second sensor element group.

16. A control method of a portable electronic apparatus comprising:
consecutively lining up and arranging a plurality of sensor elements that detect contact;
monitoring output of the plurality of sensor elements with a control unit; and
changing the control unit from a first state, in which none of the plurality of sensor elements has detected contact, to a second state after detecting that any of the sensor elements has detected contact, changing again to the first state after detecting that a state of none of the sensor elements detecting contact in the second state has continued for a certain time, and executing control, by the control unit, according to the change in the contact detection in the plurality of sensor elements occurred in the second state.

17. A portable electronic apparatus comprising:
a plurality of sensor elements; and
a control unit that detects contact to the sensor elements, wherein
the control unit
sets a first state, in which contact to the sensor elements is not detected, and a second state to which a transition is made after contact to any of the sensor elements is detected,
when the second state is set, detects a state that no contact is made to the sensor elements has continued for a certain time to set the state to the first state from the second state, and
executes control according to the change in the contact detection of the sensor elements in the second state.

18. The portable electronic apparatus according to claim 17, characterized in that
the control according to the change in the contact detection of the sensor elements is control for removing the lock of the portable electronic apparatus.

19. A portable electronic apparatus comprising:
a plurality of sensor elements; and
a control unit that detects contact to the sensor elements, wherein
the control unit
sets a first state, in which contact to the sensor elements is not detected, and a second state to which a transition is made after contact to any of the sensor elements is detected, and
when the second state is set, maintains the second state if a state that the contact to the sensor elements is not made is within a certain time.
